(19) United States
(12) Patent Application Publication
(10) Pub. No.: US 2002/0059135 A1
(43) Pub. Date: May 16, 2002

(54) System for simulating trading of financial assets

(76) Inventors: Fang Ma, Canton, MI (US); Kay Ng, Stamford, CT (US); Nan Lu, Stamford, CT (US); Bin Li, Westport, CT (US)

Correspondence Address: ST. ONGE STEWARD JOHNSTON & REENS, LLC, 986 BEDFORD STREET, STAMFORD, CT, 06905-5619, US

(21) Appl. No.: 10/047,134

(22) Filed: Jan. 15, 2002

Related U.S. Application Data
(60) Provisional application No. 60/216,929, filed on Jul. 8, 2000.

(51) Int. Cl. G06F 17/60

(52) U.S. Cl. 705/37

(57) ABSTRACT

The invention relates to a system for realistically simulating trading of financial assets. The system comprises a computer, software executing on the computer for displaying a first of the plurality of time intervals and a corresponding price, software executing on the computer for receiving an indication of a decision to trade, software executing on the computer for simulating a trade of a financial asset, software executing on the computer for repeatedly displaying a next time interval and a next corresponding price of the plurality of time intervals and corresponding prices, software executing on the computer for repeatedly receiving indications of decisions to trade, and software executing on the computer for repeatedly simulating trades.

### PRIORITY APPLICATION

This application claims the benefit, under 35 U.S.C. 119(e), of U.S. Provisional Patent Application No. 60/216,929 filed Jan. 16, 2001.

### FIELD OF THE INVENTION

The invention relates to a system for providing an environment in which to simulate a financial market and, more particularly, to a system for providing a test environment for trading assets.

### BACKGROUND OF THE INVENTION

Investors who trade stocks, bonds, securities, commodities, and other liquidities typically buy or sell financial assets via a computer having an online or Internet connection. Information upon which investors typically rely include news, personal knowledge about the market, and/or instincts. Moreover, investors generally desire additional information not usually available to the public so that they may have an early start to invest in a particular asset before others, whose later investments may drive the market price of the asset up or down. Reliable information not publicly available is advantageous because Investors who buy at a low market price may sell the asset at a higher market price when the public later drives the value upwards. Conversely, investors who buy at a high market price may choose to sell at a particular lower market price in order to cut losses. However, reliable information not yet publicly known is not often easily available. Further, it is usually difficult to distinguish reliable information from unreliable information when the public, media, or critics have not yet been able to analyze the information since it is not yet publicly available.

Therefore, investors are usually looking for other ways to invest wisely. One approach would be to sharpen an investors trading skills. Known systems require a user to specify his/her trading techniques, such as, for example, selling a technology stock when the market price is either 5 dollars above or below the buying price. Once the user's parameters have been specified, known systems will chart the performance of the technology stock as compared with actual historical performance of that stock.

A disadvantage of these systems is that an investor is not permitted to change or vary his/her parameters once they are specified. Hence, a user cannot use intuition in making trading decisions that vary from the initially specified parameters. Another disadvantage of the known systems is that an investor can specify, on a trial and error basis, various parameters until he/she achieves a successful performance when compared with historical data of that stock. This defeats the purpose of a testing environment for trading financial assets because an investor is not learning to improve his/her skills but is learning to try endless possibilities until a correct combination of parameters is found.

What is desired, therefore, is a system that provides a simulated financial market environment in which investors may improve their trading abilities. What is also desired is a testing environment that provides a realistic relation to actual financial markets. What is further desired is a testing environment that tests an investor's decision making skills as the market fluctuates. Another desire is a system that eliminates outside trading influences, such as hindsight or emotions. Still another desire is a system that educates an investor.

### SUMMARY OF THE INVENTION

Accordingly, it is an object of the invention to provide a system for simulating trading of financial assets in a realistic test environment.

It is an object of the invention to provide a system for simulating trading of financial assets that permits a user to use varying criteria when trading assets.

It is an object of the invention to provide a system for simulating trading of financial assets without disclosing information that influences an investors trading decisions.

These and other objects of the invention are achieved by a system for simulating trading of financial assets comprising a computer, software executing on the computer for displaying a first of the plurality of time intervals and a corresponding price, software executing on the computer for receiving an indication of a decision to trade, software executing on the computer for simulating a trade of a financial asset, software executing on the computer for repeatedly displaying a next time interval and a next corresponding price of the plurality of time intervals and corresponding prices, software executing on the computer for repeatedly receiving indications of decisions to trade, and software executing on the computer for repeatedly simulating trades.

The plurality of time intervals and corresponding prices may further be based upon fictitious and/or historical data. Historical data includes news, stories, events, market performance, and combinations thereof. The plurality of time intervals and corresponding prices may further be displayed graphically or in any manner that simulates a trading environment.

At the conclusion of the simulated test, the system may provide recommendations related to the user's trading performance. The recommendations may include a comparison with financial benchmarks, historical data, and/or the performances of other users.

In addition, the time intervals and prices, as well as recommendations, may be for a portfolio of assets being traded and for multiple users or investors.

The system may further include time intervals and corresponding prices that do not indicate their origin. In this manner, the test environment will not provide any information that may influence an investor's trading decisions. Hence, the time period, news, or analysis related to the displayed time intervals or prices, which may be based upon historical data, are not displayed. Further, the historical data used to provide the time intervals and price may be randomly retrieved. This further ensures that the displayed test environment will not be recognizable or predictable.

In another embodiment, the system further includes software executing on the computer for receiving a user request for specified information and software executing on the computer for displaying the specified information. For some investors, particularly beginning investors, help in making trading decisions is desired. Therefore, certain historical data, such as news surrounding the performance of the displayed time interval and corresponding price, may be requested and displayed as part of the test environment. Although the specified information will influence the user's decision making techniques, the information will typically decrease the frustration generally associated with being novice investors. However, for a realistically simulated trading environment, no specified information should be requested.

In another aspect of the invention, a method for a simulated trading environment for trading financial assets is provided. The method for simulating trading of financial assets comprises displaying a first of a plurality of time intervals of a financial asset, displaying a first corresponding price of the first time interval, receiving an indication of a decision to trade the financial asset, simulating the trade, repeatedly displaying a next time interval of the plurality of time intervals, repeatedly displaying a next corresponding price of the time interval, repeatedly receiving an indication of a decision to trade the financial asset, and repeatedly simulating the trades.

The method may further comprise the step of receiving user specified information for help in making trading decisions. Further, the method may include the step of displaying the requested specified information.

The invention and its particular features and advantages will become more apparent from the following detailed description considered with reference to the accompanying drawings.

### BRIEF DESCRIPTION OF THE DRAWINGS

FIG. 1 depicts a system for simulating trading of financial assets in accordance with the invention.

FIG. 2 depicts a method for simulating trading of financial assets in accordance with the invention.

FIG. 3 depicts an example of the recommendations provided by the system.

FIG. 4 depicts an example of the test environment provided by the system.

### DETAILED DESCRIPTION OF THE DRAWINGS

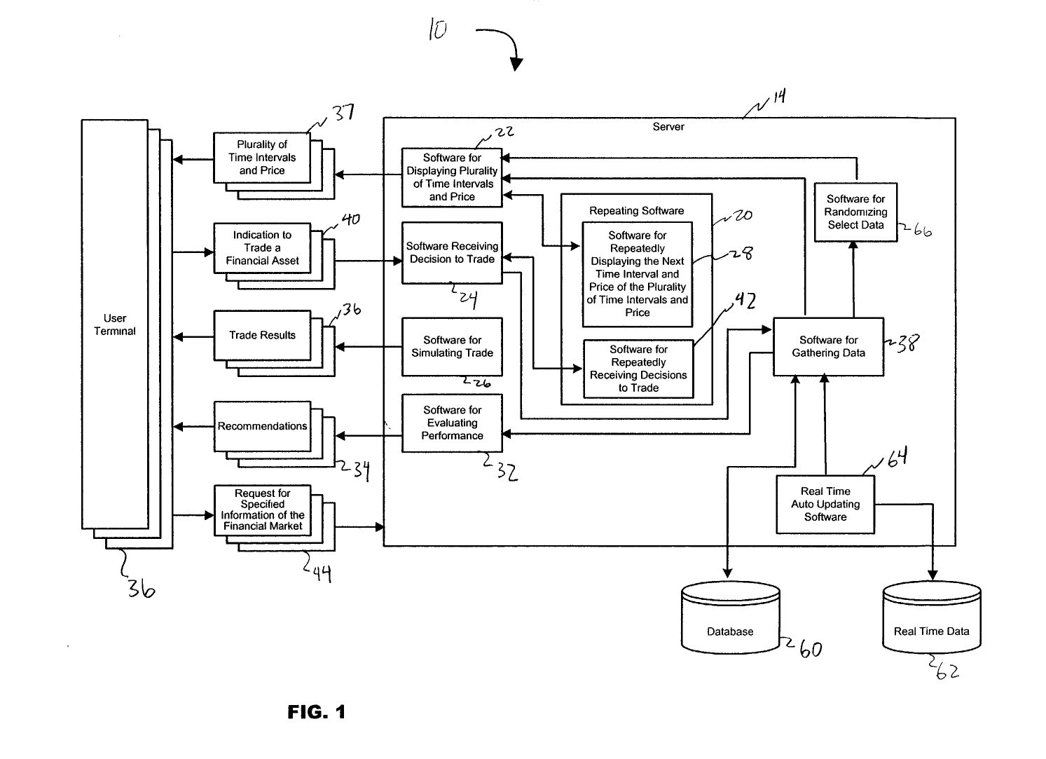

FIG. 1 depicts the system for simulating trading of financial assets in accordance with the invention. System 10 comprises computer 14, software 22 executing on computer 14 for displaying a first of a plurality of time intervals and a corresponding price, software 24 executing on computer 14 for receiving an indication of a decision to trade, software 26 executing on computer 14 for simulating a trade of a financial asset, software 28 executing on computer 14 for repeatedly displaying a next time interval and a next corresponding price of the plurality of time intervals and corresponding prices, software 42 executing on computer 14 for repeatedly receiving indications of decisions to trade, and software 20 executing on computer 14 for repeatedly simulating trades.

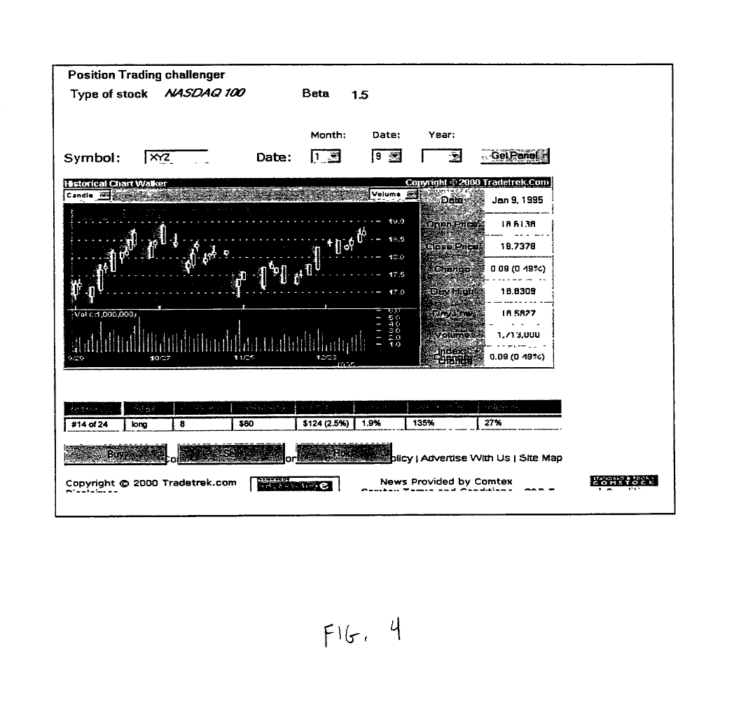

System 10 provides a testing environment for trading financial assets that realistically simulates the financial market. A financial asset's performance resulting from trades made may be shown in any manner for representing a financial asset's performance. One manner is a graphical representation of market price versus time, as shown in FIG. 4. Based on the financial asset's performance, a user, or investor, using user terminal 36 instructs system 10 to trade the financial asset. The instructions to trade are gathered by software 38 for gathering data and recorded in database 60. The users trades 36 are subsequently carried out and shown on the testing environment by software 26 executing on computer 14 for simulating the trade. This cycle of depicting a financial asset's performance and simulating a trade based upon a user's instructions is continuous for a user determined time period, at the conclusion of which software 32 executing on computer 14 for evaluating a user's performance provides recommendations 34 to the user.

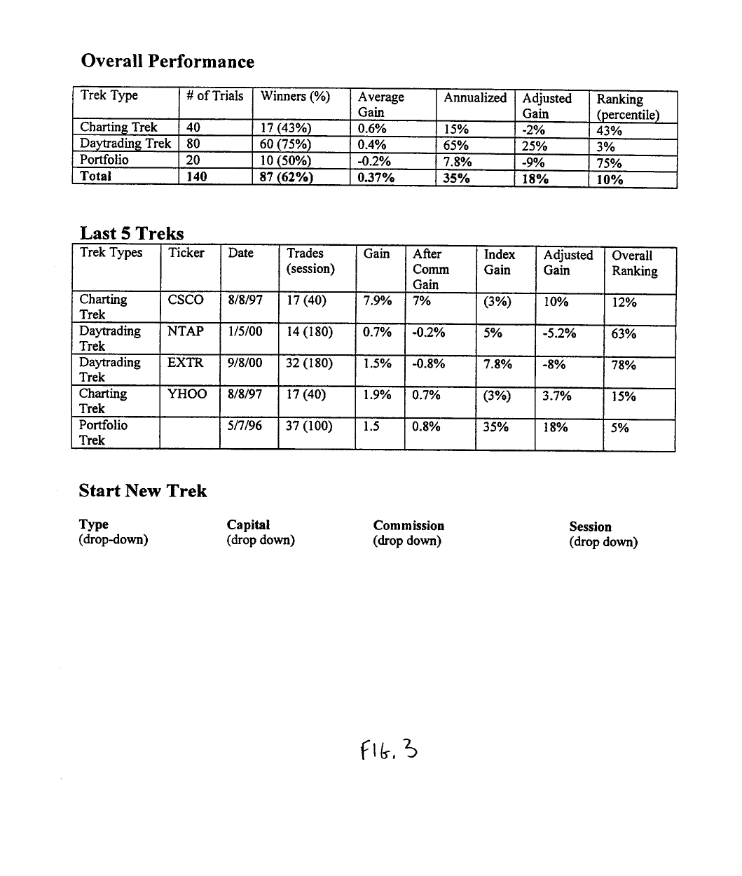

Recommendations 34 include a comparison between the user's performance of trading the financial asset and performance based on historical data of the financial asset. Recommendations 34 also include comparisons with financial benchmarks, such as the Dow Jones, S & P 500, NASDAQ, and/or Russell 2000. Recommendations 34 also include commentary, analysis, and other information related to the user's instructions to trade and historical data. Where the user has made a plurality of instructions to trade a portfolio of assets, recommendations 34 further include a comparison of all the assets with one another as well as the overall performance as compared with historical data. Where multiple users have made multiple instructions to trade, recommendations 34 include a comparison among the multiple users. In all of the above cases, statistical analysis may be used for providing percentages of accuracy and standards of deviation from historical data. An example of recommendations 34 is shown in FIG. 3.

Referring again to FIG. 1, user terminal 36 is a computer terminal in communication with computer 14. The communication may be an Internet connection or any connection for linking user terminal 36 with computer 14 so that a testing environment may be depicted on user terminal 36 from computer 14 and instructions 40 to trade may be received on computer 14 from user terminal 36.

Upon connecting to computer 14, software 22 executing on computer 14 for displaying a first of the plurality 37 of time intervals and a corresponding price displays a financial asset's performance over a single time interval and the corresponding price for that time interval. The length of the time interval is generally when a measurement of price is tallied for a financial asset and is not germane to this invention. Upon displaying a time interval and corresponding price for an asset, the user may indicate 40 a trade. An indication 40 to trade includes instructing system 10 to buy, sell, or stay.

Software 24 executing on computer 14 for receiving an indication of a decision to trade receives the user's instructions and thereafter software 26 executing on computer 14 for simulating the trade of a financial asset carries out and displays the trade for the user to see on the test environment. Software 28 then displays the next time interval and the next corresponding price and software 42 receives the next instructions for trading. The cycle repeats continuously until a predetermined time period expires. The predetermined time period is the length of time of the test and is arbitrarily determined by the user prior to beginning the test. The predetermined time period may be in terms of minutes, hours, days, weeks, months, or years.

The time intervals, price, and test environment provided by system 10 are based upon historical data stored and retrieved from database 60. The historical data includes foreign assets, domestic assets, bonds, money markets, and stock. However, system 10 does not indicate the identity of the historical data or the origin of the information used to provide the test environment. This is so that any prior knowledge the user may have about past market conditions will not influence his/her trading decisions. This ensures a realistic trading environment because investors, in actuality, are unaware of events and their future effect on an asset's performance.

Therefore, the time interval and corresponding price displayed by software 22 and software 28 are based upon an actual asset performance. Historical data surrounding the financial asset, such as the date of occurrence, news, or events, are not displayed. For example, media coverage, news, and critiques related to “Black Monday”, a day when stocks precipitously declined, occurred on Oct. 19, 1987. System 10 may provide a test environment based upon an asset's performance during the Black Monday period to test an investor's trading decisions in these elements. But during the test, the user will have no idea he/she is being subjected to the Black Monday conditions. In addition to withholding or not retrieving data identification, software 38 for gathering data from database 60 randomly gathers 66 the data upon which the time interval and price are based. This further ensures that the time interval and price displayed are not predictable or recognizable to the user.

In addition to storing historical data, database 60 is updated on a real time basis with real time data 62. Software 64 executing on computer 14 for automatically updating the database updates database 60 with current information.

In another embodiment, fictitious data is stored on database 60 in addition to, or instead of, historical data. Fictitious data is used by software 22 for displaying a time interval and corresponding price. This embodiment has all the limitations of the embodiment depicted in FIG. 1 but simply uses fictitious data in addition to, or instead of, historical data.

In another embodiment, the user may make a request 44 for specified information related to the financial market. Request 44 may be for certain news, events, historical data, or other data related to the displayed time interval and price to be known so that an investor may have assistance in making trading decisions. This may be advantageous if the user is a novice investor and desires certain data to be known to aid him/her. In this embodiment, the amount or types of specified information vary depending on request 44 submitted by the user. Although the specified information may influence an investor's decision making techniques, it generally decreases frustration often associated with being a novice investor. This embodiment does not provide the realistic test environment as shown in FIG. 1, which does not provide any specified information to influence an investor's decisions.

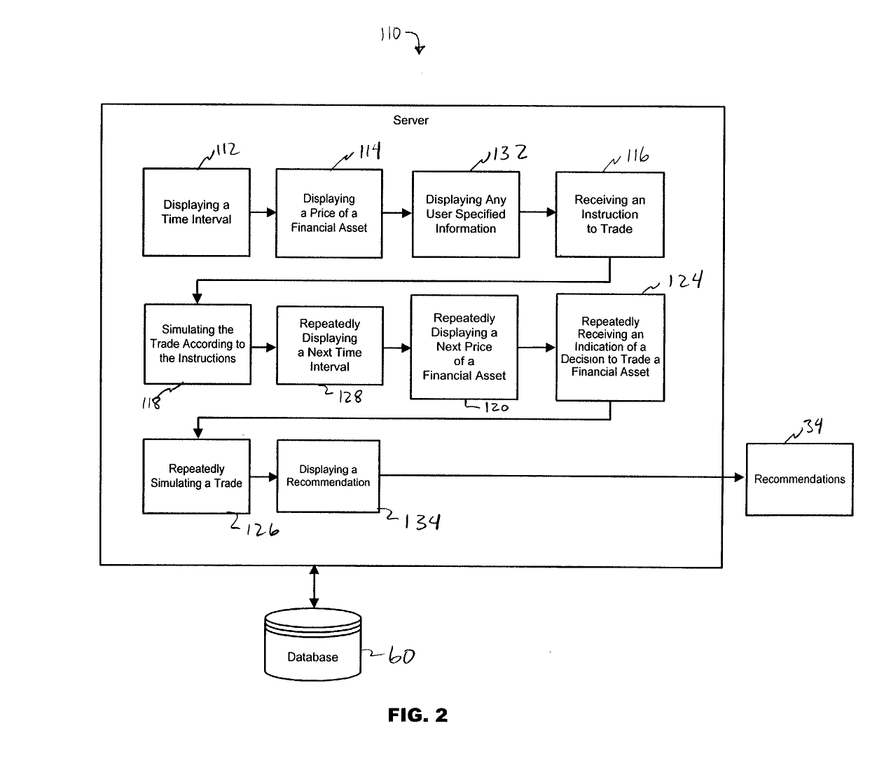

FIG. 2 depicts the method for simulating trading of financial assets in accordance with the invention. Method 110 comprises displaying 112 a first of a plurality of time intervals of a financial asset, displaying 114 a first corresponding price of the first time interval, receiving 116 an indication of a decision to trade the financial asset, simulating 118 the trade, repeatedly displaying 128 a next time interval of the plurality of time intervals, repeatedly displaying 120 the next corresponding price of the time interval, repeatedly receiving 124 an indication of a decision to trade the financial asset, and repeatedly simulating 126 the trades.

A user first begins method 110 by logging onto computer 14. Upon logging in, method 110 begins with a first step of displaying 112 a first of a plurality of time intervals of a financial asset and, contemporaneously, displaying 114 a corresponding price of the financial asset.

The next step of method 110 is receiving 116 a user instruction to trade the financial asset. This instruction includes buying, selling, or staying the financial asset. Subsequently, method 110 simulates 118 the trade according to the user instructions and displays the simulated trade for the user.

Subsequent steps of method 110 are repeatedly displaying 128 the next time interval of the plurality of time intervals, repeatedly displaying 120 the next corresponding price of the time interval, repeatedly receiving 124 indications of trade decisions, and repeatedly simulating 126 the trade. These steps continue cyclically until the test is completed, whereupon the method displays 134 a recommendation to the user regarding his/her performance.

Optionally, a user may request that specific information be displayed in addition to the time interval and price. The specified information, typically news or other historical data, would be an aid for helping the user make trading decisions and is generally for novice investors. If such a request is made, method 110 displays 132 the user specified information as part of the test environment.

Although the invention has been described with reference to a particular arrangements of parts, features and the like, these are not intended to exhaust all possible arrangements or features, and indeed many other modifications and variations will be ascertainable to those of skill in the art.

What is claimed is:

1. A system for simulating trading of financial assets, comprising:
a computer;
software executing on said computer for displaying a first time interval and a first corresponding price of a plurality of time intervals and corresponding prices;
software executing on said computer for receiving an indication of a decision to trade;
software executing on said computer for simulating the trade;
software executing on said computer for repeatedly displaying a next time interval and a next corresponding price of the plurality of time intervals and corresponding prices;
software executing on said computer for repeatedly receiving indications of decisions to trade based upon said next time interval and said next corresponding price of the plurality of time intervals and corresponding prices; and
software executing on said computer for repeatedly simulating trades based upon said repeatedly received indications of decisions to trade.

2. The system according to claim 1, wherein said plurality of time intervals and corresponding prices are based on fictitious data.

3. The system according to claim 1, wherein said plurality of time intervals and corresponding prices are based on historical data.

4. The system according to claim 3, wherein said historical data is selected from the group consisting of news, stories, events, market performance, and combinations thereof.

5. The system according to claim 1, wherein the plurality of time intervals and corresponding prices are displayed graphically.

6. The system according to claim 1, further comprising software executing on said computer for displaying a recommendation based upon the decisions to trade.

7. The system according to claim 1, further comprising software executing on said computer for evaluating performance as compared to financial benchmarks.

8. The system according to claim 1, further comprising software executing on said computer for providing a plurality of time intervals and corresponding prices for a portfolio of financial assets.

9. The system according to claim 1, further comprising software executing on said computer for receiving indications of trades from a plurality of users.

10. The system according to claim 9, further comprising software executing on said computer for evaluating performance as compared to other users.

11. The system according to claim 1, wherein the displayed time intervals and corresponding prices do not indicate their source of origin.

12. The system according to claim 1, wherein the plurality of time intervals and corresponding prices are based upon randomly selected historical data.

13. A system for simulating trading of financial assets, comprising:
a computer;
software executing on said computer for receiving a request to display specified information;
software executing on said computer for displaying a first time interval and a first corresponding price of a plurality of time intervals and corresponding prices;
software executing on said computer for displaying specified information;
software executing on said computer for receiving an indication of a decision to trade;
software executing on said computer for simulating the trade;
software executing on said computer for repeatedly displaying a next time interval and a next corresponding price of the plurality of time intervals and corresponding prices;
software executing on said computer for repeatedly receiving indications of decisions to trade based upon said next time interval and said next corresponding price of the plurality of time intervals and corresponding prices; and
software executing on said computer for repeatedly simulating trades based upon said repeatedly received indications of decisions to trade.

14. The system according to claim 13, wherein said specified information is requested by a user.

15. The system according to claim 13, wherein said specified information is selected from the group consisting of news, stories, events, market performance, a historical time period, and combinations thereof.

16. A method for providing a simulated trading environment for trading financial assets, comprising the steps of:
providing a computer;
displaying a time interval on said computer;
displaying a price of a financial asset corresponding to said time interval;
receiving an indication to trade the financial asset;
simulating the trade according to said indication to trade;
repeatedly displaying a next time interval and a next corresponding price of a plurality of time intervals and corresponding prices;
repeatedly receiving indications of decisions to trade based upon said next time interval and said next corresponding price; and
repeatedly simulating trades based upon said repeatedly received indications of decisions to trade.

17. The method according to claim 16, further comprising the step of receiving user specified information.

18. The method according to claim 17, further comprising the step of displaying said user specified information.
